(19) United States
(12) Patent Application Publication
(10) Pub. No.: US 2012/0234616 A1
(43) Pub. Date: Sep. 20, 2012

(54) FUEL TANK SYSTEM

(75) Inventors: Ryan S. Jaskowiak, Mukwonago, WI (US); Kirk G. Burlage, Oconomowoc, WI (US)

(73) Assignee: Briggs & Stratton Corporation

(21) Appl. No.: 13/048,780

(22) Filed: Mar. 15, 2011

(51) Int. Cl. B60K 15/035; B65D 25/04

(52) U.S. Cl. 180/69.4; 220/500

(57) ABSTRACT

A fuel tank includes a body, a partition, and an opening in the partition. The body has an interior configured to receive and store liquid fuel. The partition substantially divides the interior of the body into upper and lower volumes. The opening in the partition provides fluid communication between the upper and lower volumes, and is located proximate to one of the walls of the body. The fuel tank further includes a fill port and a vent that is coupled to the upper volume away from the opening.

### BACKGROUND

The present application relates generally to the field of fuel tanks Such fuel tanks may be configured for use with portable generators or other outdoor power equipment.

A portable generator or other type of outdoor power equipment may be driven by an internal combustion engine. The fuel tank for the engine is designed with materials and a structure configured to receive and carry liquid fuel, such as gasoline, diesel, ethanol, or other liquid fuels. The fuel is poured into the fuel tank through a fill port and is stored within an interior of the fuel tank. The fuel may then be provided to the engine via a fuel line.

Some fuel tanks include a vent to relieve internal pressures in the fuel tank caused by gaseous vapors that are produced and/or expand in the fuel tank. The vent may also allow for air to enter the fuel tank as fuel is drained from the fuel tank, relieving vacuum pressures in the fuel tank. However, if the fuel tank is tipped or tilted such that the portion of the vent interior to the fuel tank becomes submerged in liquid fuel, then the fuel may leak through the vent. When the fuel tank is tipped or tilted, an air pockets may float to the opposite side of the tank, and collect additional air as fuel leaks out and air leaks in through the vent.

### SUMMARY

One embodiment of the invention relates to a fuel tank, which includes a body, a partition, and an opening in the partition. The body has an interior configured to receive and store liquid fuel. The partition divides the interior of the body into upper and lower volumes, except for the opening in the partition that allows fuel and vapors to pass between the upper and lower volumes. The opening in the partition may be located proximate to one of the walls of the body. The fuel tank further includes a fill port and a vent that is coupled to the upper volume away from the opening in the partition and the fill port.

Another embodiment of the invention relates to a portable generator, which includes a frame, wheels coupled to the frame, and an engine at least partially supported by the frame. The portable generator further includes a fuel tank coupled to the engine, where the fuel tank includes a body, a partition, and an opening within the interior of the body. The body of the fuel tank has an interior configured to receive and store liquid fuel. The partition divides the interior of the body into upper and lower volumes. Further, the partition is at least partially sealed to walls of the body, except for the opening within the interior of the body, which allows vapors and fuel to pass between the upper and lower volumes. The opening is located proximate to one of the walls of the body. The fuel tank further includes a fill port and a vent that is coupled to the upper volume away from at least one of the opening and the fill port.

Yet another embodiment of the invention relates to outdoor power equipment, which includes a work implement, an engine configured to drive the work implement, and a fuel tank coupled to the engine. The fuel tank includes a body, a partition, and an opening in the partition. The body of the fuel tank has an interior configured to receive and store liquid fuel. The partition divides the interior of the body into upper and lower volumes, and the partition is at least partially sealed to walls of the body. The opening in the partition allows vapors to pass between the upper and lower volumes, and is located proximate to one of the walls of the body. The fuel tank further includes a fill port and a vent that is coupled to the upper volume away from the opening in the partition.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, in which:

FIG. 1 is a perspective view of a portable generator according to an exemplary embodiment of the invention.

FIG. 2 is a sectional view of a fuel tank according to an exemplary embodiment of the invention, taken along line 2-2 as shown in FIG. 4.

FIG. 3 is a sectional view of the fuel tank of FIG. 2, taken along line 3-3 as shown in FIG. 4.

FIG. 4 is a top view of the fuel tank of FIG. 2.

FIGS. 5-6 are sectional views of the fuel tank of FIG. 3 tipped 30-degrees in opposite directions about a longitudinal axis L, as shown in FIGS. 2 and 4.

FIGS. 7-8 are sectional views of the fuel tank of FIG. 2 tipped 30-degrees in opposite directions about a transverse axis T, as shown in FIGS. 3 and 4.

FIGS. 9-10 are sectional views of the fuel tank of FIG. 3 tipped 90-degrees in opposite directions about the longitudinal axis L, as shown in FIGS. 2 and 4.

FIGS. 11-12 are sectional views of the fuel tank of FIG. 2 tipped 90-degrees in opposite directions about the transverse axis T, as shown in FIGS. 3 and 4.

FIGS. 13-15 are side views of the fuel tank of FIG. 2 tipped 30-degrees about the transverse axis T, as shown in FIGS. 3 and 4, with varying degrees of internal vapor expansion.

FIG. 16 is a sectional view of a fuel tank according to another exemplary embodiment of the invention, taken along line 16-16 as shown in FIG. 17.

FIG. 17 is a top view of the fuel tank of FIG. 16.

FIGS. 18-19 are sectional views, taken along line 16-16 as shown in FIG. 17, of the fuel tank of FIG. 16 tipped in opposite directions.

FIG. 20 is a side view of a fuel tank according to yet another exemplary embodiment of the invention.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Some embodiments of the invention disclosed herein include fuel tanks and outdoor power equipment designed to overcome a problem with venting of fuel tanks, that problem being containment of fuel during tipping, temperature changes, or combinations of both. If a tank is completely sealed to prevent fuel leakage, there is a possibility of creating a pressure vessel during a temperature rise and corresponding fuel vapor expansion. Some embodiments disclosed herein are designed to allow for fuel tank tip angles up to 90-degrees in any direction and beyond in some instances, while still allowing vapors to be vented without fuel leakage through the vent.

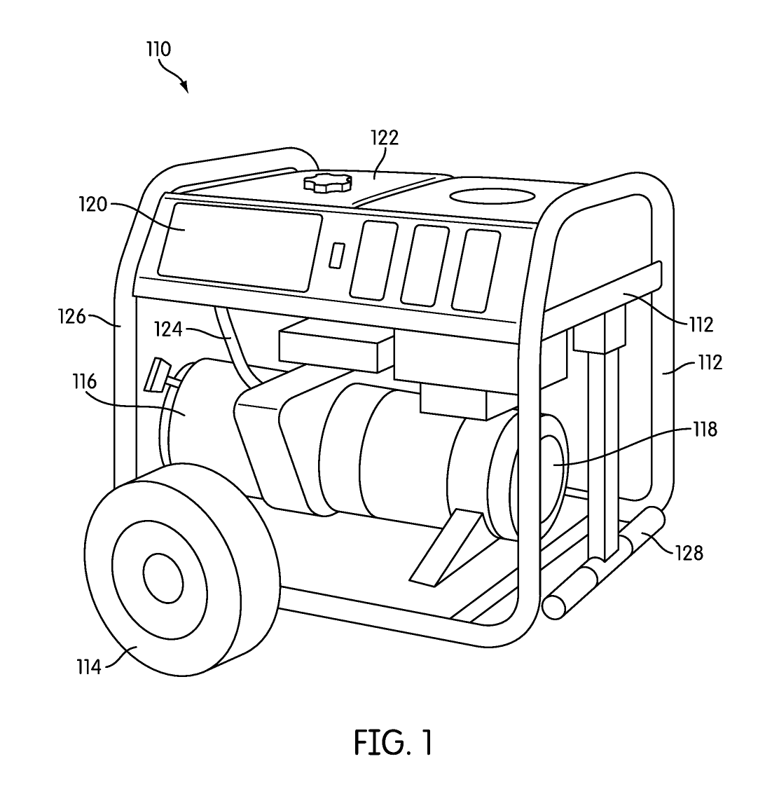

Referring to FIG. 1, a portable generator 110 includes a frame 112, wheels 114 coupled to the frame 112, and an engine 116 at least partially supported by the frame 112. The engine 116 is configured to drive a work implement in the form of an electrical generator 118. A surface coupled to the frame 112 includes a control panel 120 that allows an operator to interface with control circuitry configured to operate the engine 116 and electrical generator 118.

According to an exemplary embodiment the portable generator 110 includes a fuel tank 122 supported by the frame 112 and coupled to the engine 116 by way of a fuel line 124 (e.g., passage, conduit). The fuel tank 122 may be mounted to the frame 112 above the engine 116, and extend from one side of the portable generator 110 to the other, behind the control panel 120. The fuel tank 122 may be formed from metal, such as pressed steel or tin plate; a polymer, such as polyethylene or nylon; or another material or combination of materials.

In some embodiments, the frame 112 includes a network of tubular members 126 that provide support and structure for other components of the portable generator 110. The wheels 114 may be mounted to the frame 112 via an axle or other attachment integrated with the frame 112. A handle 128 or other surface integrated with the frame 112 allows the operator to roll the portable generator 110 to a desired location for operation. According to an exemplary embodiment, the wheels 114 are robust and configured to operate on rugged and uneven terrain.

According to an exemplary embodiment, the fuel tank 122 is designed to prevent fuel from leaking from the fuel tank 122 when the portable generator 110 is tilted as may occur while the portable generator is transported over hills, raised and lowered around obstacles, or even if the portable generator 110 should happen to fall over 90-degrees onto a side of the portable generator 110—all while maintaining the ability to vent pressurized vapors from the fuel tank 122 without fuel leakage. The fuel tank 122 may also be configured to prevent leaks if the portable generator 110 is completely rolled over, such as by way of a roll-over valve integrated with a vent of the fuel tank 122.

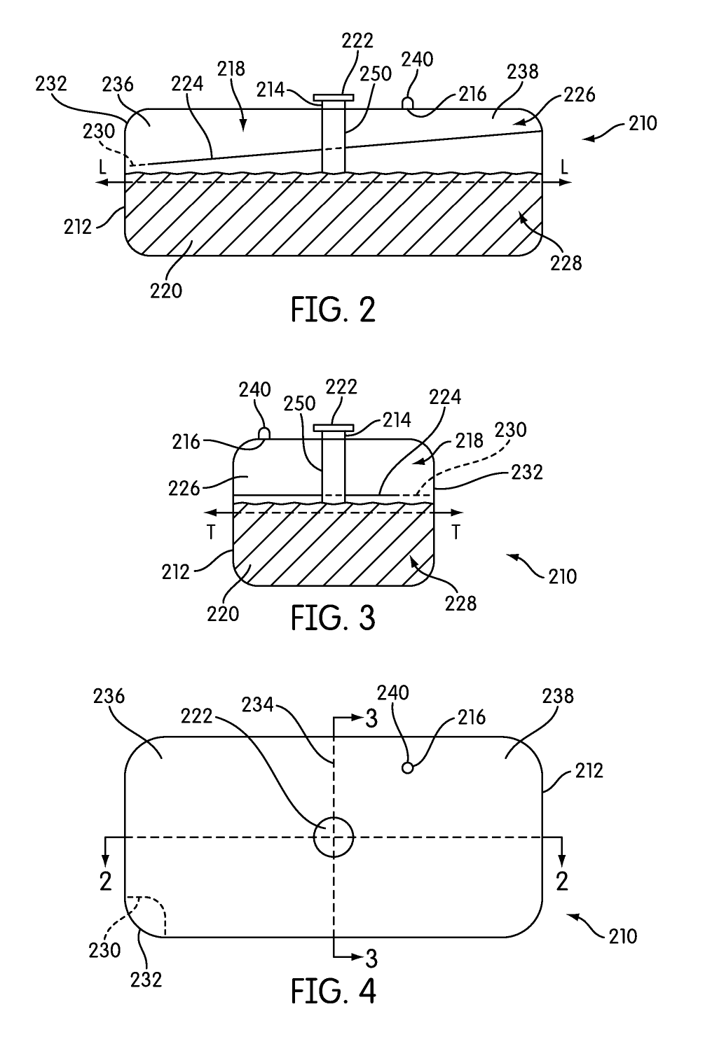

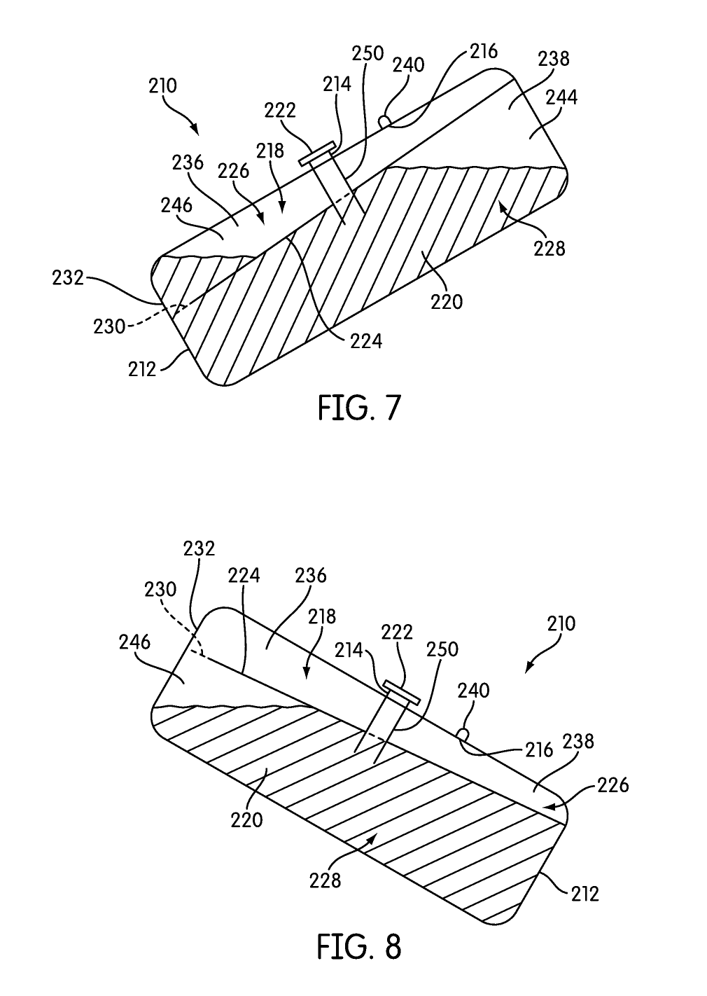

Referring to FIGS. 2-4 a fuel tank 210 includes a container body 212, a fill port 214, and a vent 216 (e.g., vent port). The container body 212 has an interior 218 configured to receive and store liquid fuel 220. The fill port 214 serves as an aperture through which fuel may be provided to the interior 218 of the container body 212. The fuel tank shown in FIGS. 2-4 is generally rectilinear in shape. In contemplated embodiments, a tank may include curved sides and may be otherwise shaped. In some contemplated embodiments, a tank includes additional features such as an outlet for a fuel line, a release valve, a fuel level sensor, and other features. In some contemplated embodiments, some or all of the walls of the container may be transparent, translucent, or partially translucent. In other embodiments, the walls are opaque.

According to an exemplary embodiment, the vent 216 is located on or proximate to the top of the fuel tank 210 and extends from the interior 218 of the container body 212, through a wall of the container body 212. In some embodiments, the vent 216 is coupled to a venting conduit (e.g., tube) that directs vapors provided through the vent 216 to an air intake of the engine, a carbon canister for filtering, or elsewhere.

In some embodiments, the fuel tank 210 includes a cap 222 (e.g., fuel cap, gas cap, lid) designed to be fastened or unfastened to the fill port 214 to close or open, respectively, the fill port 214. In some embodiments, a vent may be integrated with a cap for a fill port, while in other embodiments the vent 216 is separate from the cap 222 and spaced apart from the fill port 214 on the container body 212. In some such embodiments, when the cap 222 is fastened to the fill port 214, the fill port 214 is sealed such that neither liquid nor gas may pass through the fill port 214.

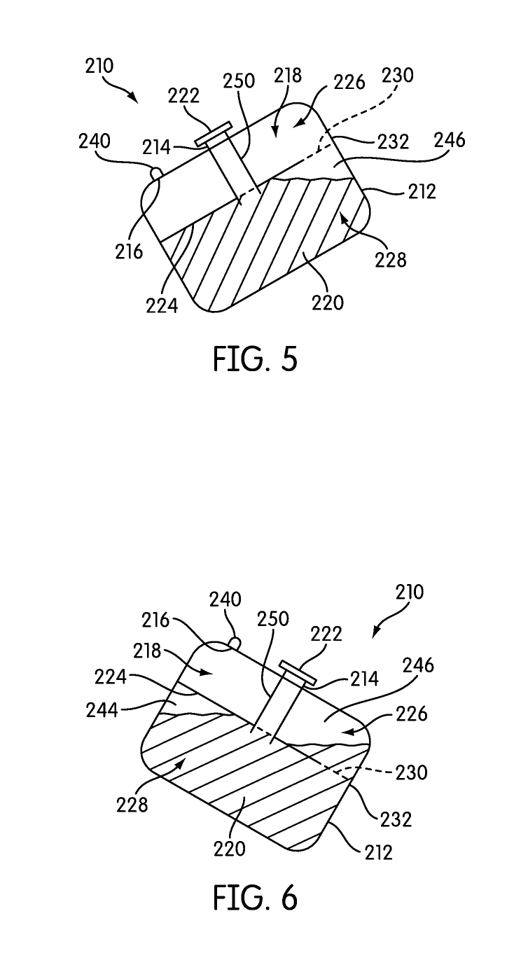

According to an exemplary embodiment, the fuel tank 210 further includes a partition 224 (e.g., baffle, separator, divider, wall, plate) within the fuel tank 210, which divides the interior 218 of the container body 212 into upper and lower volumes 226, 228, where the upper volume 226 is located at least partially vertically above the lower volume 228 when the fuel tank 210 is in an upright orientation (see FIGS. 2-3). The lower volume 228 is intended to hold the liquid fuel 220. According to an exemplary embodiment, the magnitude (i.e., volume) of the upper volume 226 is less than the magnitude of the lower volume 228.

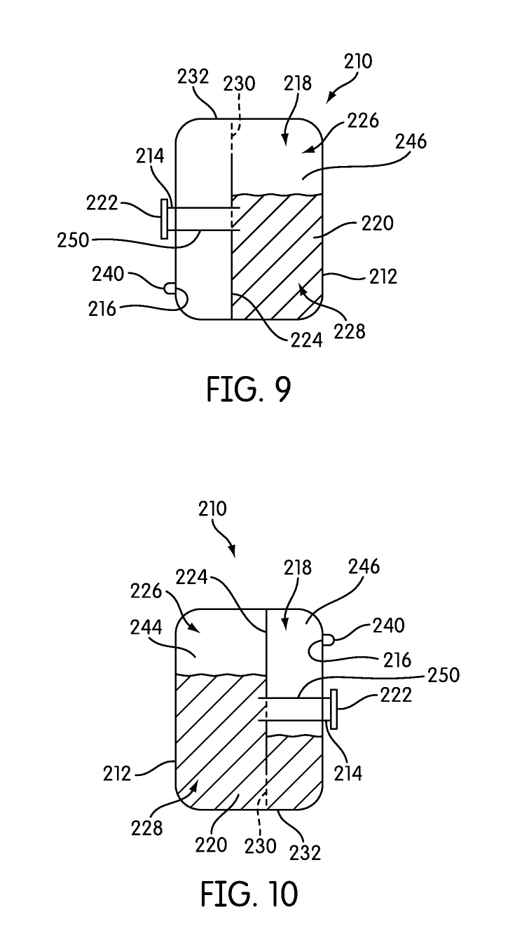

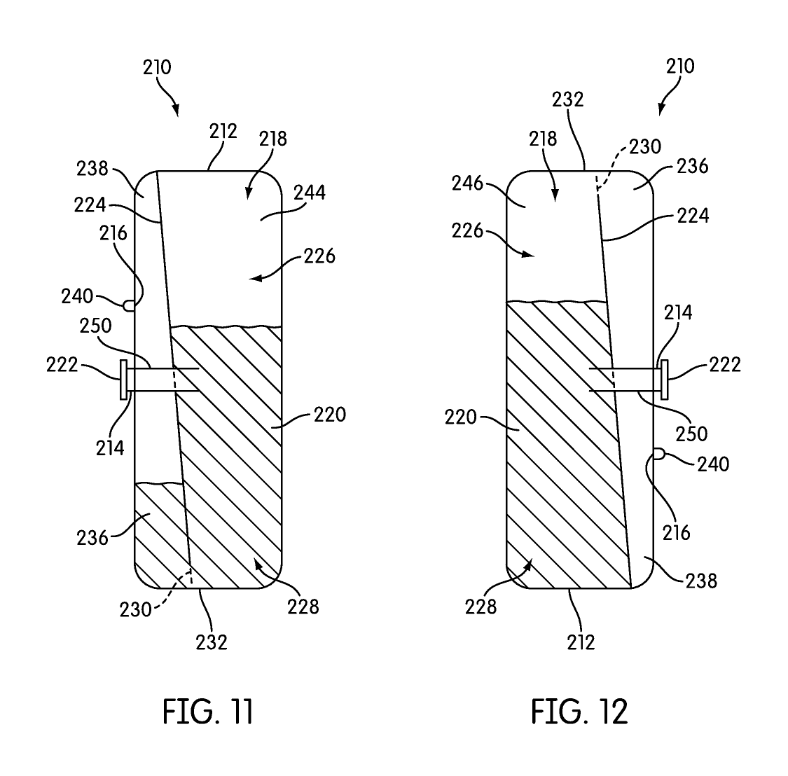

The fuel tank 210 further includes an opening 230 within the interior 218 of the container body 212 that allows vapors and/or liquid to pass between the upper and lower volumes 226, 228. As such, the opening 230 provides a passage through or around the partition 224. In some embodiments, the opening 230 is located proximate to one of the walls of the container body 212, such as within six inches from the wall in some such embodiments, or contacting the wall of the container body 212 in other such embodiments. According to an exemplary embodiment, the walls of the container body 212 form a corner 232, and the opening 230 is located proximate to the corner 232, such as less than six inches from the corner 232 in some such embodiments, or adjacent to the corner 232 in other such embodiments. Six inches or less between the opening 230 and the walls or corner 232 may be an approximate distance for liquid fuel to reach and flow through the opening 230 when the fuel tank 210 is tipped toward the opening 230 as shown in FIGS. 6-7, while preventing fuel from flowing through the opening 230 when the fuel tank 210 is tipped away from the opening 230 as shown in FIGS. 5 and 8. However in other contemplated embodiments, the distance between the opening and the walls or corner is greater than six inches, such as for some embodiments including larger fuel tanks In contemplated embodiments, the opening is in the middle of a wall, as opposed to in a corner. In some such embodiments, the opening may be aligned with longitudinal or transverse axes L, T.

The vent 216 is coupled to the upper volume 226 away from the opening 230, such as on an opposite side of the fuel tank 210 from the opening 230. In some embodiments, the vent 216 is located at least as far from the opening 230 as the fill port 214 is located from the opening 230. In some such embodiments a vent is integrated with the fill port 214, adjacent to the fill port 214, or integrated with the cap 222.

According to an exemplary embodiment, the vent 216 is located further from the opening 230 than the fill port 214 is located from the opening 230. In some such embodiments, the fill port 214 is located generally between the opening 230 and the vent 216. The vent 216 may be located at least proximate to a wall or corner of the container body 212 that is substantially opposite to the location of the opening 230. In at least one contemplated embodiment, the fill port is located further from the opening than the vent is located from the opening, where both the fill port and vent are located substantially opposite to the opening.

Referring to FIGS. 2-4, a plane 234 is defined as orthogonal to the longitudinal axis L and aligned with the transverse axis T. Accordingly, the plane 234 extends transversely through the fuel tank 210 such that the plane 234 bisects the fuel tank 210 into first and second halves 236, 238. In some such embodiments, the opening 230 is located in the first half 236 and the vent 216 is located in the second half 238.

In contemplated embodiments, the vent 216 is located away from the opening 230. In some embodiments, the vent 216 is located away from the opening 230 by a distance that is a fraction of the average width of the fuel tank 210 in the transverse direction of the fuel tank 210, such as at least a half, at least a quarter, at least an eighth, at least three-quarters, or another portion of the width. In some embodiments, the vent 216 is located away from the opening 230 by a distance that is a fraction of the average length of the fuel tank 210 in the longitudinal direction, such as at least a half, at least a quarter, at least an eighth, at least three-quarters, or another portion of the length. In some embodiments, the vent 216 is located away from the opening 230 by a distance that is a fraction of the magnitude of the greatest line segment bisecting a section of the fuel tank 210 intersecting the center of the fuel tank 210, such as at least a half, at least a quarter, at least an eighth, at least three-quarters, or another portion of the line segment.

According to an exemplary embodiment, the partition 224 is sealed to walls of the container body 212. The seal prevents vapor and liquid fuel from passing through or around the partition 224, other than through the opening 230. In contemplated embodiments, the opening is less than ten-percent of the surface area of the partition 224, such as less than five-percent. In some embodiments, the partition 224 is sealed to the walls by being integrally formed with the walls (e.g., molded therewith). In other embodiments, the partition is sealed to the walls via adhesives, welding, crimping edges together, compression fit, gaskets, or by other forms of fasteners and sealants.

Still referring to FIGS. 2-4, the fuel tank 210 further includes a neck 250 (e.g., filler neck, conduit, passage) extending into the interior 218 of the container body 212 from the fill port 214. The neck 250 passes through the partition 224 and connects the fill port 214 with the lower volume 228. According to an exemplary embodiment, the neck 250 connects directly to the lower volume 228, and the opening 230 is the only passage between the upper and lower volumes 226, 228. The partition 224 and exterior of the neck 250 may be sealed to one another, such as by welding, pressure fit, adhesives, gaskets, sealants, or other such means.

The fuel tank 210 is designed such that the fuel level corresponding to a “full tank” (e.g., maximum recommended level) occurs when the tank 210 is filled to the bottom of the neck 250. The bottom of the neck 250 is located at a height approximately matching that of the opening 230, such as where both the bottom of the neck 250 and the opening 230 are substantially on a horizontal plane (e.g., a plane orthogonal to the plane 234) intersecting the opening 230 between the upper and lower volumes 226, 228. In other embodiments, the bottom of the neck 250 is located within the interior 218 at a height above then bottom of the fuel tank 210 that is less than, but at least proximate to, that of the opening 230, such as less than two inches closer to the bottom than the opening 230, or such as between about a quarter of an inch and an inch closer to the bottom than the opening 230. In other embodiments, the bottom of the neck 250 may be another vertical distance from the opening.

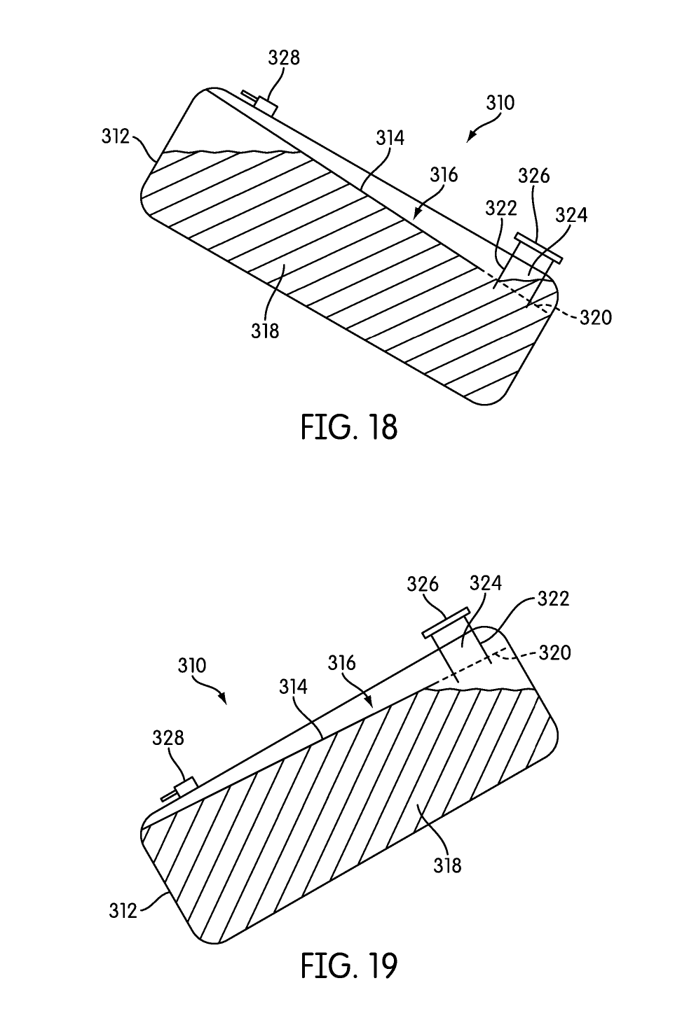

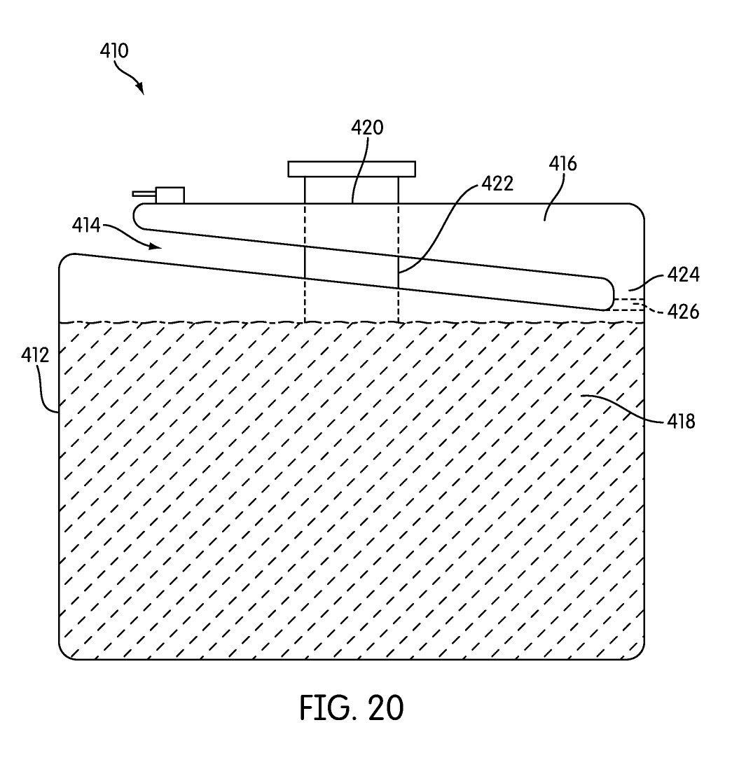

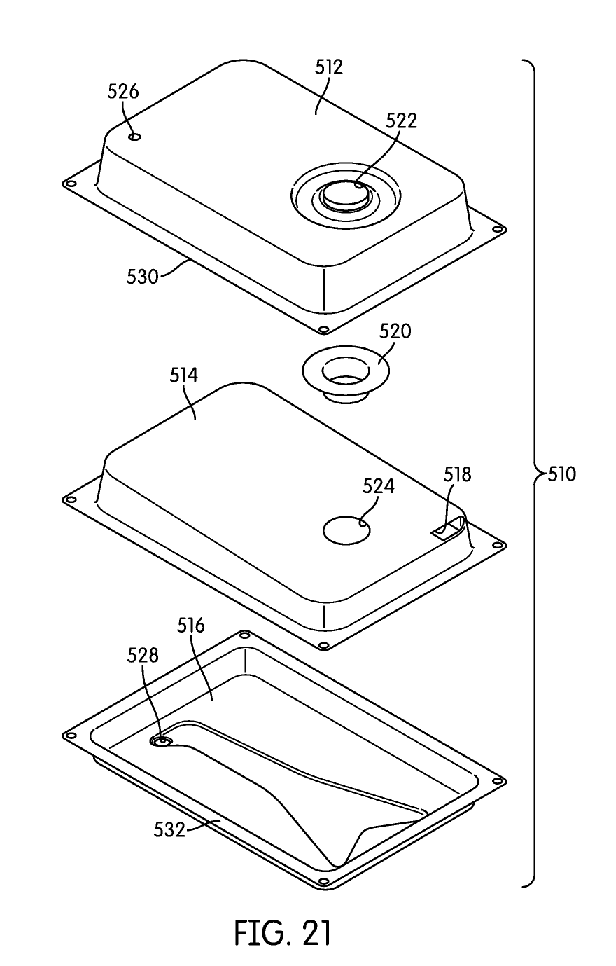

According to an exemplary embodiment, the neck 250 and partition 224 are sealed to one another where the neck 250 passes through the partition 224, to prevent vapor and/or liquid fuel from passing through or around the partition 224. In some such embodiments, the partition 224 is fastened to both the neck 250 and the top of the container body 212, providing structural support to the top of the container body 212 by transferring loads to the partition 224. In other contemplated embodiments, a neck passes around a partition to a lower volume without passing through the partition (see generally FIGS. 16-19).

In some embodiments, the partition 224 is or includes a flat plate or wall that extends from one end of the tank 210 to the opposite end, and is sealed all the way around on the inside of the walls of the container body 212, with the exception of the opening 230. In other contemplated embodiments, the partition may be curved, stepped, or otherwise shaped. In some embodiments, the plate or otherwise-structured partition 224 is generally sloped downward toward the opening 230 at an average angle, which in various contemplated embodiments ranges from about half of one-degree to five-degrees, such as about two degrees. In other contemplated embodiments, the angle is greater than five-degrees (e.g., ten-degrees, sixty-degrees) or less than half of one-degree. Sloping of the partition 224 may provide a gradient to guide liquid fuel toward the lower volume 228. In other contemplated embodiments, a partition is horizontal, not sloped. The partition may have a constant or changing thickness and constant or changing slope.

Referring to FIGS. 2-4, the fuel tank 210 may further include a valve 240 (e.g., check valve, roll-over valve). In some embodiments the valve 240 is integrated with the vent 216. In other contemplated embodiments, a valve may be integrated with the opening between the upper and lower volumes of the interior of the container body.

According to an exemplary embodiment, the valve 240 is configured to open or close as a function of the orientation of the fuel tank 210. In some such embodiments, if the tank 210 is tipped greater than 90-degrees the valve 240 will close. The valve 240 may be controlled mechanically, electronically, hydraulically, or otherwise, as a function of gravity acting upon a weight coupled to a mechanical linkage, a load cell, etc., or other systems responsive to orientation.

While the fuel tank 210 of FIGS. 2-4 is generally box-shaped, other contemplated embodiments include fuel tanks with a wide range of complex shapes. A fuel tank may include more than one vent. Furthermore, a fuel tank may include an outlet or aperture at least proximate to a bottom of the fuel tank and coupled to a fuel line (see e.g., fuel tank 122 and fuel line 124 as shown in FIG. 1). In other contemplated embodiments, a fuel tank (e.g., portable gas can or jerrycan) may not include such an outlet. The vent may be coupled to a carburetor, a fuel injector, or another component via a venting conduit. In still other embodiments, a fuel tank may be integrated with a blower housing of an engine.

Referring to FIGS. 5-8, when tipped, the fuel tank 210 uses a combination of a vacuum space 244 (e.g., vapor pocket, low-pressure volume, sub-atmospheric-pressure volume) and an area 246 vented to the atmosphere to relieve internal changes in pressure in the fuel tank 210 relative to atmospheric pressure, while preventing leaks through the vent 216. Referring specifically to FIGS. 5 and 8, when the fuel tank 210 is tipped away from the opening 230, the area 246 (e.g., the entire air space in the tank) is vented to the atmosphere or a vapor recovery system, allowing the temperature to increase in the fuel tank 210 without causing the internal pressure of the fuel tank 201 increase.

Positioning the vent 216 on the top of the container body 212, somewhat inside from the corner opposite to the opening 230, allows for a small amount of liquid fuel to be present in the upper volume 226 and to collect in the corner opposite to the opening 230 without reaching the vent 216. For example, although not shown in FIG. 8, a small amount of liquid fuel may be present in the upper volume 226, and may collect near a corner or wall opposite to the opening 230 without reaching the vent 216, which is spaced apart from the corner or wall. As such, when tipped away from the opening 230 the partition 224 blocks most of the liquid fuel 220 from leaking through the vent 216, and the remaining amount of liquid fuel 220 is insufficient to reach the vent.

Referring now to FIGS. 6-7, when the fuel tank 210 is tipped about the longitudinal and/or transverse axes L, T such that the opening 230 is lowered vertically (i.e., tipped toward the opening 230), the vacuum space 244 is formed behind the liquid fuel 220 and underside of the partition 224. Some liquid fuel 220 from the lower volume 228 flows through the opening 230, blocking gases from entering the opening 230 to fill the vacuum space 244. However, suction upon the liquid fuel 220 provided by the vacuum space 244 restrains the liquid fuel 220 from flowing too far into upper volume 226. The liquid fuel 220 does not reach the vent 216 in such embodiments. Accordingly, when the fuel tank 210 is tipped toward the opening 230, gaseous vapors may still be vented to the atmosphere but the tank 210 does not leak liquid fuel 220 through the vent 216. Subsequently, when the tank 210 is righted, gravity draws the liquid fuel 220 in the upper volume 226 back through the opening 230 to the lower volume 228.

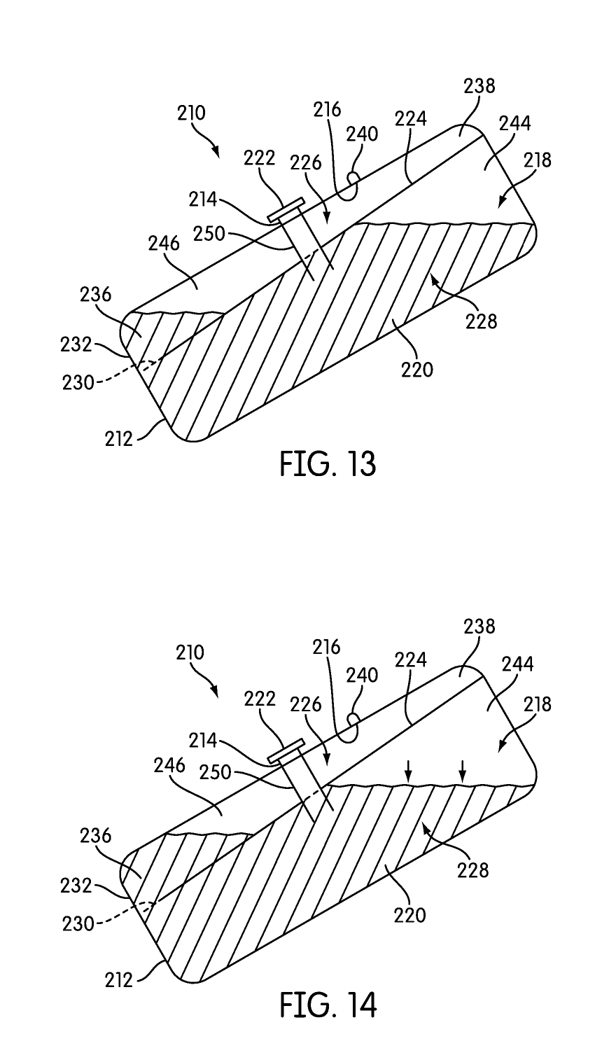

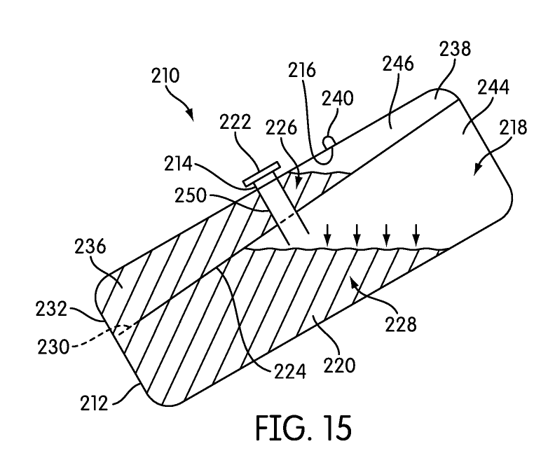

Referring now to FIGS. 9-12, the fuel tank 210 is configured to prevent leakage through the vent 216 while allowing for at least a 90-degree tip orientation, as may correspond to a portable generator or other outdoor power equipment falling over onto a side thereof. In some embodiments, this works for tipping or tilting about both the longitudinal and transverse axes L, T because of the opening 230 between the upper and lower volumes 226, 228 is located in the corner of the partition 224, which allows the opening 230 to act the same in either direction or in a combination of directions.

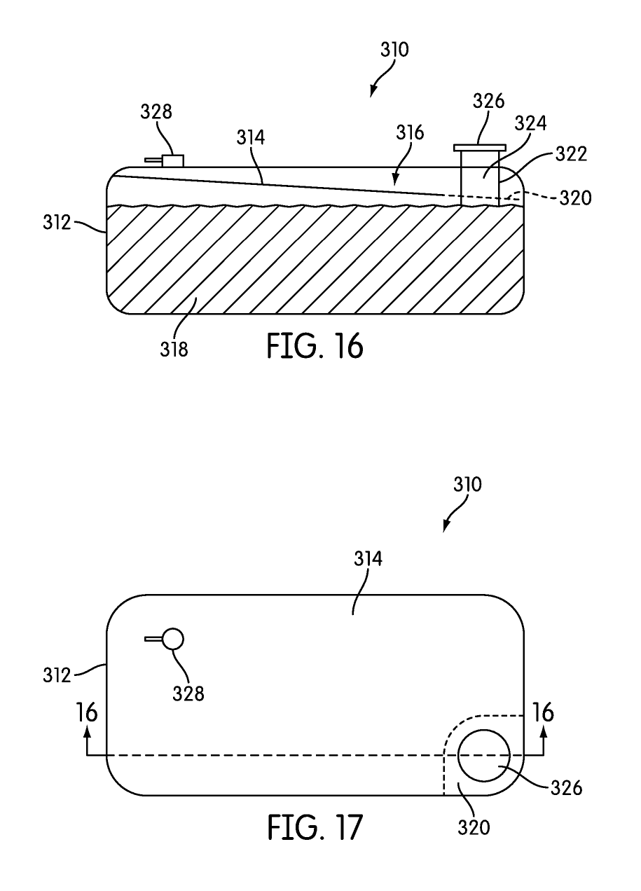

Referring to FIGS. 13-15, once tipped in the direction of the opening 230, an increase in temperature may cause gases expand, and the vacuum space 244 to increase in magnitude. The increase the vacuum space 244 will allow more fuel from the lower volume 228 to flow into the upper volume 226. However, because the vent 216 is coupled to the upper volume 226 sufficiently away from the opening 230 between the upper and lower volumes 226, 228, the liquid fuel flowing into the upper volume 226 is unable to reach the vent 216. Accordingly, in such embodiments the tank 210 will continue to vent vapors to the atmosphere without leaking, despite the change in temperature and tilt. There will be no increase in internal pressure in the upper volume 226 in the fuel tank 210 due to temperature.

Referring now to FIGS. 16-19, a fuel tank 310 includes a container body 312 and a partition 314 within the container body 312. The partition 314 divides the interior of the container body 312 into upper and lower volumes 316, 318. An opening 320 is formed between the upper and lower volumes 316, 318. A neck 322 extends from a fill port 324 to the lower volume 318. According to an exemplary embodiment, the fill port 324 and neck 322 are located proximate to the opening 320. As such the neck 322 extends to the lower volume 318 without passing through the partition 314. In some such embodiments, the neck 322 may contact an edge of the partition 314. In other such embodiments, the neck 322 may not contact the partition 314 at all. A cap 326 may be fastened to the fill port 324 to seal the fill port 324 closed. A vent 328 is located on the top of the container body 312 substantially opposite to the opening 320 and fill port 324. In some embodiments, the vent 328 includes a roll-over valve designed to shut the vent 328 should the fuel tank 310 rotate more than ninety degrees in any direction from the upright orientation, with the fill port 324 and the vent 328 substantially vertically extending from the top surface of the fuel tank 310.

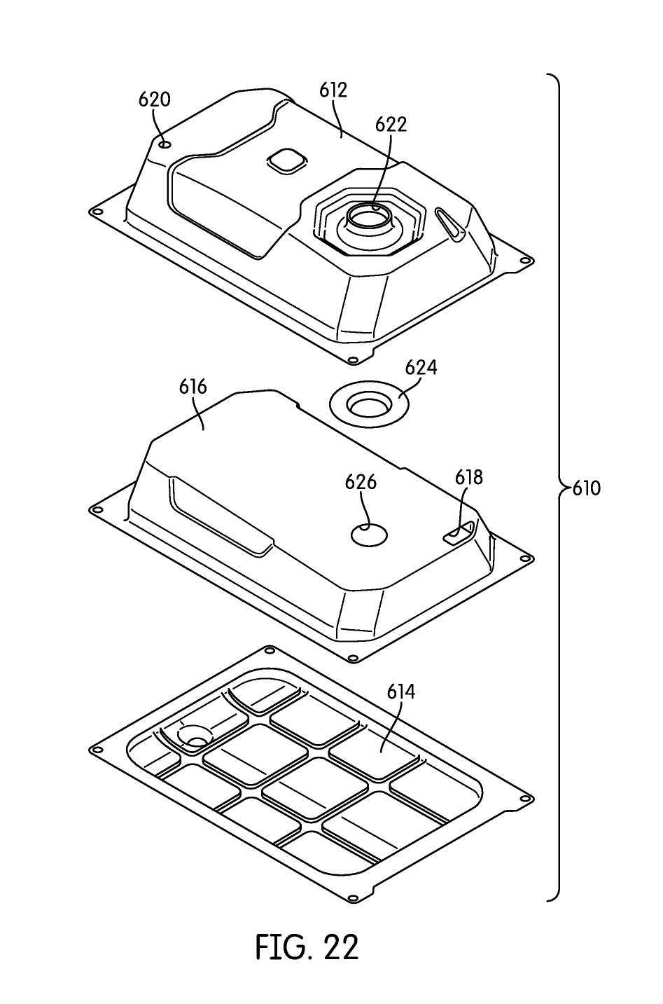

Referring now to FIG. 20, a fuel tank 410 includes a container body 412 and a partition 414. The fuel tank of FIG. 20 operates in a manner similar to the tanks 210 and 310, however the partition 414 is formed by walls of the container body 412 that are also constructed to form upper and lower volumes 416, 418. The container body 412 may be molded as a single, integral body. In some such embodiments, the fuel tank 410 includes a fill port 420 and a neck 422 directed to the lower volume 418. The partition 414 may be downward sloping toward an opening 424 between the upper and lower volumes 416, 418, and may include one or more drainage passages 426 to allow liquid on the exterior of the tank (e.g., rain water) to flow out of a pocket formed by the walls forming the partition 414.

In contemplated embodiments, a fuel tank as disclosed herein, may be used with engines of a broad range of outdoor power equipment other than portable generators. In some embodiments, a fuel tank may be used as the fuel tank for a pressure washer, a snow thrower, a walk-behind lawn mower, a riding lawn mower, a tractor, a rotary tiller, a log splitter, a wood chipper, or another form of outdoor power equipment. Work implements for such outdoor power equipment may include blades, augers, impellers, pumps, wheels, saws, or other work implements. In contemplated embodiments, fuel tanks include capacities suitable for portable generators, such as from about 3 gallons to about 10 gallons. In other embodiments, fuel tanks include capacities less than 3 gallons, or more than 10 gallons.

In various contemplated embodiments, a fuel tank may be mounted to the engine of the power equipment, or may be mounted separately to the power equipment and coupled to the engine via a fuel line. In other contemplated embodiments, the fuel tank may be used with an engine that is not used with outdoor power equipment. In still other contemplated embodiments, containers other than fuel tanks may use technology disclosed herein. In some such embodiments, containers designed for brake fluid, liquid coolant, hydraulic fluid, and other fluids may use an internal partition and vent or other features disclosed herein.

Referring now to FIG. 21, a fuel tank 510 includes a first piece, a second piece, and a third piece. According to an exemplary embodiment, the first piece is an upper portion 512 of the fuel tank 510 (e.g., first clam shell stamping), the second piece is a baffle 514 (e.g., plate, partition), and the third piece is a lower portion 516 of the fuel tank 510. Each of the pieces may be formed by stamping one or more sheets of metal (e.g., steel). The baffle 514 includes an opening 518 proximate to a corner of the baffle 514, which may cut from the baffle 514 during stamping of the baffle 514.

According to an exemplary embodiment, a conduit 520 may sized to extend between a fill port 522 on the upper portion 512 to interface with an opening 524 on the baffle 514. In some embodiments, the conduit 520 is sealed to the baffle 514 such that fluid cannot pass between the exterior of the conduit 520 and the baffle 514. In some embodiments, the upper portion 512 includes a vent 526, and the lower portion 516 of the fuel tank 510 includes an outlet 528 that may lead to a fuel line or other conduit.

During manufacturing of the fuel tank 510, the pieces of the fuel tank 510 may be arranged such that the baffle 514 is fastened between the upper and lower portions 512, 516. In some embodiments, the upper and lower portions 512, 516 are welded together along edges 530, 532 of the upper and lower portions 512, 516. In other embodiments, the upper and lower portions 512, 516 are fastened together with threaded fasteners and sealed with one or more gaskets. In some embodiments, the upper and lower portions 512, 516 are adhered together. In other embodiments, corresponding edges 530, 532 of the upper and lower portions 512, 516 are crimped together, fastening the baffle 514 between the upper and lower portions 512, 516. In still other embodiments, the upper and lower portions 512, 516 are otherwise coupled.

Referring now to FIG. 22, a fuel tank 610 for a portable generator (see, e.g., portable generator 110 as shown in FIG. 1), includes upper and lower portions 612, 614 that fasten together over a baffle 616. The baffle 616 separates an internal volume of the fuel tank 610 into upper and lower volumes. An opening 618 in the baffle 616 provides fluid communication between the upper and lower volumes. Additionally, the fuel tank 610 includes a vent 620, a fill port 622, and conduit 624. The conduit 624 extends from the fill port 622 in the upper portion 612, through a hole 626 or otherwise around the baffle 616 to the lower volume, which is at least partially defined by the lower portion 614 and the underside of the baffle 616. The baffle 616, in combination with the opening 618, serves to prevent leaks of liquid fuel through vent 620 when the fuel tank 610 tips or tilts.

The construction and arrangements of the fuel tank and outdoor power equipment, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A fuel tank, comprising:
a body having an interior configured to receive and store liquid fuel;
a partition substantially dividing the interior of the body into upper and lower volumes;
an opening in the partition providing fluid communication between the upper and lower volumes, wherein the opening is located proximate to one of the walls of the body;
a fill port; and
a vent coupled to the upper volume away from the opening.

2. The fuel tank of claim 1, wherein the vent is located at least as far from the opening as the fill port is located from the opening.

3. The fuel tank of claim 2, wherein the vent is located further from the opening than the fill port is located from the opening.

4. The fuel tank of claim 1, wherein the opening is located in a first half of the fuel tank and the vent is located in a second half

5. The fuel tank of claim 1, wherein the partition slopes downward toward the opening.

6. The fuel tank of claim 5, wherein the partition comprises a plate.

7. The fuel tank of claim 5, wherein the walls of the body form a corner, and wherein the opening is located proximate to the corner.

8. The fuel tank of claim 7, wherein the fuel tank is substantially rectilinear.

9. The fuel tank of claim 7, further comprising a conduit extending from the fill port through the partition to the lower volume.

10. The fuel tank of claim 9, wherein the partition and an exterior portion of the conduit are sealed to one another.

11. The fuel tank of claim 10, further comprising:
a cap configured to be fastened to the fill port to close the fill port and unfastened from the fill port to open the fill port, wherein when the cap is fastened to the fill port, the fill port is sealed.

12. The fuel tank of claim 10, further comprising:
a check valve coupled to the vent, wherein the check valve is configured to close the vent if the fuel tank rolls over.

13. The fuel tank of claim 5, wherein the opening is located proximate to a middle of a wall of the body.

14. The fuel tank of claim 1, further comprising:
a cap configured to be fastened to the fill port to close the fill port and unfastened from the fill port to open the fill port, wherein the vent is integrated with the cap.

15. A portable generator, comprising:
a frame;
wheels coupled to the frame;
an engine at least partially supported by the frame; and
a fuel tank coupled to the engine, the fuel tank comprising:
a body having an interior configured to receive and store liquid fuel;
a partition dividing the interior of the body into upper and lower volumes, wherein the partition is at least partially sealed to walls of the body;
an opening within the interior of the body allowing vapors to pass between the upper and lower volumes, wherein the opening is located proximate to one of the walls of the body;
a fill port; and
a vent coupled to the upper volume away from the opening.

16. The portable generator of claim 15, wherein the partition of the fuel tank slopes downward toward the opening within the interior of the body of the fuel tank.

17. The portable generator of claim 16, wherein two walls of the body form a corner, and wherein the opening is located proximate to the corner.

18. Outdoor power equipment, comprising:
a work implement;
an engine configured to drive the work implement; and
a fuel tank coupled to the engine, the fuel tank comprising:
a body having an interior configured to receive and store liquid fuel;
a partition dividing the interior of the body into upper and lower volumes, wherein the partition is at least partially sealed to walls of the body;
an opening in the partition allowing vapors to pass between the upper and lower volumes, wherein the opening is located proximate to one of the walls of the body;
a fill port; and
a vent coupled to the upper volume away from the opening.

19. The outdoor power equipment of claim 18, further comprising a conduit extending from the fill port of the fuel tank through the partition of the fuel tank to the lower volume of the fuel tank.

20. The outdoor power equipment of claim 19, wherein the partition slopes downward toward the opening within the interior of the body.

21. The outdoor power equipment of claim 20, wherein two walls of the body of the fuel tank form a corner, and wherein the opening is located proximate to the corner.

22. A fuel tank, comprising:
a container body;
a partition provided within the container body, the partition sloping from a first side of the container body to a second side of the container body, the partition dividing the container body into upper and lower volumes;
an opening formed in the partition near the first side; and
a vent provided away from the opening.
